(19) United States
(12) Patent Application Publication
(10) Pub. No.: US 2007/0009720 A1
(43) Pub. Date: Jan. 11, 2007

(54) Vibration damping material and motion guide device where the material is assembled

(75) Inventors: Hidekazu Michioka, Tokyo (JP); Katsuya Iida, Yamanashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 10/558,396

(22) PCT Filed: May 25, 2004
(86) PCT No.: PCT/JP04/07100

§ 371 Date: Nov. 28, 2005

(30) Foreign Application Priority Data
May 30, 2003 (JP) 2003155351
May 19, 2004 (JP) 2004148908

(51) Int. Cl. B32B 7/02

(52) U.S. Cl. 428/212

(57) ABSTRACT

A plurality of thin metal layers 8 and a plurality of thin attenuation layers 9 are laminated one by one alternately. The entire thickness of the laminated damping structure is set to be not more than 1.0 mm. According to this structure, since a plurality of boundary faces exist between the metal layers 8 and the attenuation layers, oscillation energy is easily converted to friction energy, thus providing a large attenuation force. In addition, since the entire thickness is set to be not more than 1.0 mm, deformation amount of the damping structure 6 due to shearing force can be made small, so that rigidity of the damping structure 6 can be increased.

### FIELD OF THE INVENTION

The present invention relates to a damping structure possessed with an attenuation or damping function, and more particularly, to a damping structure to apply the attenuation function to a guide system for guiding relative movement of a table with respect to a base.

### BACKGROUND TECHNOLOGY

There is known a guide system for guiding a table with respect to a base. Such guide system includes a track rail mounted to the base and a movable block mounted to the table to be slidable along the track rail. In order to ensure a smooth sliding motion of the movable block with respect to the track rail, rolling members such as balls, rollers or like, performing rolling motion, are arranged between the track rail and the movable block.

When the table is rapidly stopped after the movement of the table by using a driving mechanism such as a ball screw, the table is oscillated or vibrated in its advancing direction. In a case where a guide system is assembled in a machine tool, a part mounting machine, a semiconductor/liquid-crystal manufacturing apparatus and so on, an operator must wait for carrying out a working to the guide system till the oscillation or vibration ceases, and accordingly, it is necessary to attenuate or damp the oscillation.

In a conventional guide system, in order to attenuate the oscillation of the table, there is adopted a preloading method in which an internal load is applied to a rolling member. For example, rolling members, each having an outer diameter larger than a gap between a rolling member rolling groove formed to the track rail and a rolling member rolling groove of the movable block, are disposed between the track rail and the movable block. If the internal load is applied to the rolling member, friction resistance ceased at a time when the rolling member rolls on the rolling member rolling groove becomes large, and hence, a moving rigidity is improved. Furthermore, the oscillation (vibration) energy can be converted into heat energy, thereby attenuating the oscillation.

### DISCLOSURE OF THE INVENTION

### PROBLEMS TO BE SOLVED BY THE INVENTION

However, according to the structure mentioned above, by giving the internal load to the rolling member, a resistance is increased at a time when the movable block slides with respect to the track rail, and as a result, usable life time of the rolling member will be made short.

In the meantime, there is also known, as an aseismatic structure for protecting a building from earthquake, a laminated rubber structure interposed between the building and its fundamental structure. Such laminated rubber structure is formed from iron plates and rubbers which are alternately laminated, and the laminated rubber structure has a high rigidity against a perpendicular load and is deformed in the horizontal direction, thus providing a large attenuation (damping) function.

However, the conventional laminated rubber structure generally has a not so large thickness (height), for example, of 10 to 20 mm, which is not suitable for assembling it in a guide system required to be made small in size. Moreover, according to such height, deformation amount of the laminated rubber structure due to horizontal load (i.e., shearing force) becomes large. In this viewpoint, such conventional laminated rubber structure is not suitable for the guide system to which a high rigidity is required.

The present invention then aims to provide a compact damping structure capable of achieving high attenuation performance and providing high rigidity.

### MEANS FOR SOLVING THE PROBLEM

Hereunder, the present invention will be described.

In order to solve the above problem, the inventors of the subject application conceived the lamination structure of a plurality of thin metal layers and a plurality of thin attenuation layers, each having a Young's modulus different from that of the metal layer, and set the entire thickness to be extremely thin, which has not been conceived in a conventional laminated rubber structure.

That is, the invention of claim 1, in order to solve the above problem, provides a damping structure comprising a plurality of thin metal layers and a plurality of thin attenuation layers each having a Young's modulus different from that of the metal layer, the metal layers and attenuation layers being laminated one by one alternately so as to provide an entire thickness of the damping structure to be not more than 1.0 mm.

In a viewpoint that high attenuation performance can be achieved and high rigidity can be also achieved, it is desired that the damping structure has the entire thickness of not more than 0.5 mm, and that the metal layer has a thickness of 20 to 40 μm and the attenuation layer has a thickness of 5 to 10 μm.

In an embodiment in which the attenuation layer is composed of a rubber or resin layer and is printed on the metal layer, the thickness of the attenuation layer to be laminated can be made thin.

In an embodiment in which a boundary face between the metal layer and the attenuation layer provides a corrugated shape having crests and troughs continuously alternately, an area of the boundary face can be increased, thus achieving further improved attenuation performance.

Furthermore, the present invention provides a motion guide device comprising a track rail and a movable block arranged to be slidable along the track rail, wherein a plurality of thin metal layers and a plurality of thin attenuation layers, each having a Young's modulus different from that of the metal layer, are laminated one by one alternately so as to provide an entire thickness of the damping structure to be not more than 1.0 mm.

Still furthermore, the present invention provides a guide system comprising a base, a table and a motion guide device arranged between the base and the table so that the table is relatively movable with respect to the base, wherein the motion guide device includes a track rail mounted to the base and a movable block mounted to the table to be slidable along the track rail, in which a plurality of thin metal layers and a plurality of thin attenuation layers, each having a Young's modulus different from that of the metal layer, are laminated one by one alternately so as to provide an entire thickness of the damping structure to be not more than 1.0 mm.

According to the present invention of the characters mentioned above, the attenuation performance of the damping structure can be enhanced. In addition, the rigidity thereof can be also increased. That is, an amount of deformation of the damping structure due to shearing force can be made small, and a compression load to be applied can be made large.

Furthermore, the damping structure can be assembled, without making design change of the movable block, by an additional working, such as cutting, of the upper surface of the movable block.

Still furthermore, since a plurality of attenuation layers are disposed, the heat generated on the table side can be shut off from transferring to a motion guide device, providing an heat insulating function.

### BRIEF DESCRIPTION OF THE DRAWINGS

FIG. 1 is a perspective view showing a guide system incorporated with a damping pad according to one embodiment of the present invention.

FIG. 2 is a partial sectional view of the guide system of FIG. 1.

FIG. 3 is a sectional view of the damping pad.

FIG. 4 is a schematic view showing a distortion due to a shearing force.

FIG. 5 is a perspective view showing a motion guide device.

FIG. 6 is a sectional view of a damping pad according to another embodiment of the present invention.

### EXPLANATION OF REFERENCE NUMERALS

1—base

2—table

3—track rail

4—movable block

6—damping pad

8—metal layer

9—attenuation layer

Best Mode for Embodying the Invention

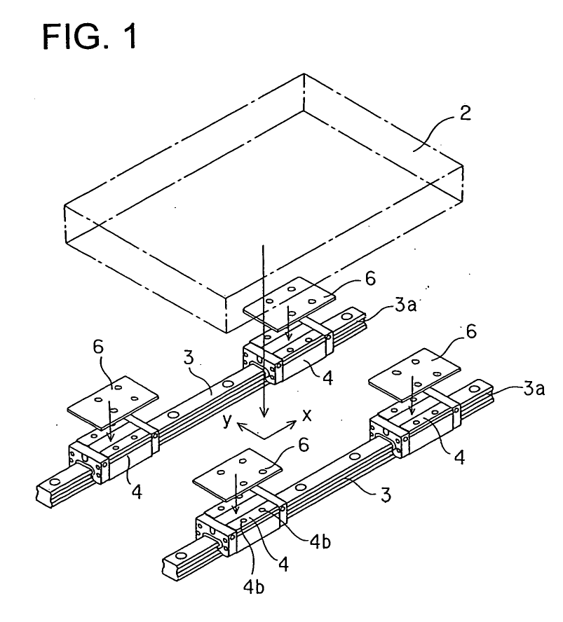

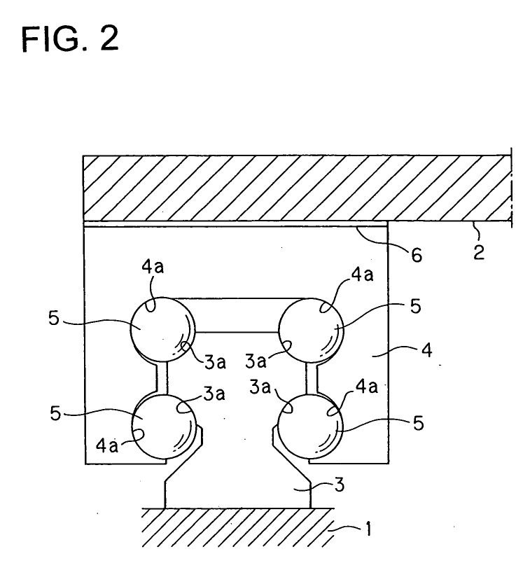

FIG. 1 and FIG. 2 represent a guide system incorporated with a damping structure according to one embodiment of the present invention. The guide system is used for a machine tool such as machining center, lathe, milling machine or like, a parts mounting machine such as robot for mounting parts to an electric circuit board, and a semiconductor or liquid-crystal manufacturing machine such as Dicer or wire-bonder, or like, and the guide system is adopted to support a linear motion or curvilinear motion of a table 2 with respect to a base 1.

A track rail 3 extending finely is attached to the base 1. A straddle-type movable block 4 is mounted to the track rail 3 to be slidable along the track rail 3. The table 2 is attached to the upper surface of the movable block 4. In this embodiment, although two track rails 3, 3 and four movble blocks 4,—are arranged, the numbers of the track rails 3 and movable blocks 4 may be changed or set in accordance with machines to be utilized.

A number of balls 5,—are interposed, as rolling members, between the track rail 3 and the movable block 4 so that the movable block 4 can smoothly slide. These balls 5,—roll and move between a ball rolling groove 3a finely extending along the track rail 3 and a loaded ball rolling groove 4a formed inside the movable block 4 so as to oppose to the ball rolling groove 3a. The details of the motion guide device constituted by these track rails 3 and the movable blocks 4 will be described hereinlater.

A damping pads 6,—, as a damping structure, each having a thin thickness and rectangular shape corresponding to the flat shape of the movable block 4. The table 2 is, for example, linearly moved in an X-direction on the drawing by a driving mechanism such as ball screw or like, not shown. When the table 2 is rapidly stopped, the table 2 oscillates (vibrates) in the X-direction. In a case where such guide system is incorporated in a machine tool, an operator cannot carry out the next working step till such oscillation ceases, and on the other hand, in a case where such guide system is incorporated in a part mounting machine, an operator cannot mount parts till the oscillation ceases. The damping pad 6 according to this embodiment can resist against and attenuate the oscillation of the table in every direction in the X-Y plane to thereby quickly converge the oscillation.

The damping pad 6 will be fixed between the movable block 4 and the table 2 in the following manner. Scrw holes 4b,—are formed in an upper surface of the movable block 4, bolt holes are formed to the table 2 and the damping pad 6 for inserting bolts, and the table 2 and the damping pad 6 are fixed to the movable block 4 by means of fastening means such as bolt. In this fixing operation, bolt fastening torque is controlled such that these three members are not integrated and the table 2 is slightly deformable with respect to the movable block 3. In another way, the movable block 4 and the damping pad 6 may be bonded, or the damping pad 6 and the table 2 may be bonded.

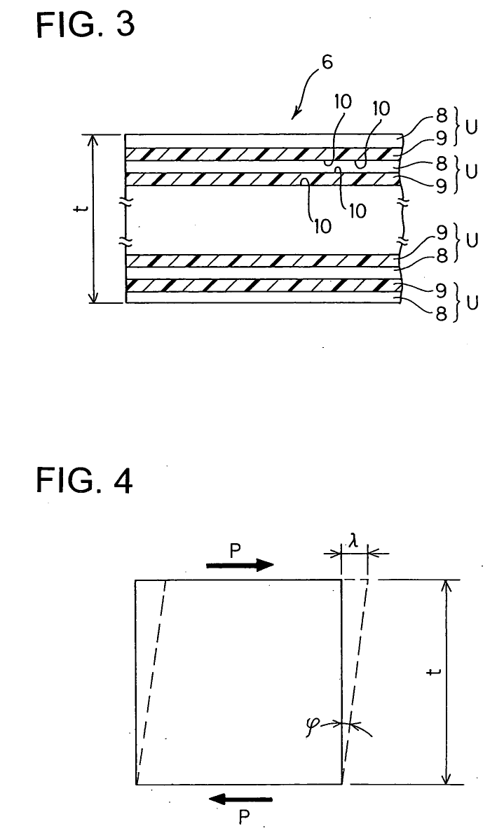

FIG. 3 shows the sectional view of the damping pad 6. The damping pad 6 is constituted by alternately laminating a plurality of thin metal layers and a plurality of attenuation layers having a Young's modulus different from that of the metal layers. More specifically, the metal layers 8,—are formed from a plurality of thin stainless or iron flat-plate-shaped metal layers, and the attenuation layers 9,—are formed from a plurality of thin rubber or cement flat-plate-shaped layers such that these layers 8 and 9 are alternately laminated one by one. The damping pad 6 in this embodiment is formed from a plurality of laminated units U, each being composed of the metal layer 8 on which the attenuation layer 9, made of rubber, is printed. The units U to which the attenuation layers 9 are printed do not bonded to each other. The attenuation layer 9 is formed in a manner that liquid-state rubber having an attenuation function is screen-printed on the entire surface of the metal layer 8 and the liquid-state rubber is thereafter hardened through heating process, for example. In the other ways, there may be adopted a method in which a rubber sheet rested on a metal plate is heated and pressurised, or a method in which a rubber layer is formed on a metal plate through an injection molding process.

Further, in order to obtain a large attenuation force, it is desired not to bond the units U together, but it may be possible to bond the units U together in consideration of easy handling thereof. The outermost layer of the damping pad 6 may be constituted with the metal layer 8 or attenuation layer 9. Otherwise, the metal layer 8 positioned outside may be calked so as to provide an integrated damping pad.

The characteristic feature of the damping pad 6 of the present embodiment resides in the formation of the laminated layer structures of thin metal layers 8 and attenuation layers 9 through a boundary face 10 disposed between respective adjacent layers 8 and 9. One of reasons why the location of a plurality of boundary faces 10 serves to provide a large attenuation force will be as follows. When a shearing force is applied to the damping pad 6, there acts a force to cause displacement at the boundary face 10 between the metal layer 8 and the attenuation layer 9, and according to such displacement, a friction force is caused to the boundary face 10, which converts a oscillation energy to a heat energy, thus generating the attenuating force. Hence, the location of a plurality of such boundary faces 10 causes a large friction force and, hence, generates a large attenuating force.

In a specific structure, the metal layer 8 has a thickness of 20 to 80 μm and the attenuation layer 9 has a thickness of 5 to 10 μm. The entire thickness of the damping pad 6 is set to be less than 1 mm, and approximately 0.5 mm in this embodiment. In a case of the metal layer 8 and the attenuation layer 9 having thicknesses more than those of the above, the number of layers to be laminated will be reduced, and hence, the attenuation force will be reduced. On the other hand, in a case of the metal layer 8 and the attenuation layer 9 having thicknesses less than those of the above, a compression load in the thickness direction to be loaded will be reduced.

The reason why the entire thickness of the damping pad is made less than (not more than) 1 mm, and approximately 0.5 mm in this embodiment will be described hereunder.

When the table 2 shown in FIG. 1 is rapidly stopped, the shearing force P is applied to the damping pad 6 as shown in FIG. 4. When the shearing force P is applied, the upper surface is displaced by an amount of λ with respect to the lower surface. This λ is an amount of displacement caused by the shearing force P. Supposing that the damping pad is displaced by an amount of λ with respect to the thickness t, a shearing strain φ will be expressed as φ=λ/t. In the strength of materials, in the case that the shearing force P is constant, the shearing strain φ is also constant, so that when the thickness t becomes large, the displacement λ also becomes large. Accordingly, by making extremely thin, such as about 0.5 mm, the entire thickness of the damping pad 6, the displacement due to the shearing force can be made possibly small. On the other hand, for a conventional architectural lamination rubber having thickness of about 20 mm, the displacement λ becomes too large, and hence, it is not suitable for a guide system to which high rigidity is required.

Another reason why the thickness of the damping pad is set to be about 0.5 mm in this embodiment resides in that the damping pad 6 can be incorporated in the movable block 4 by carrying out an additional working, for example, cutting the upper surface of the movable block 4 without changing the design of the existing movable block 4. Since it is not necessary to change the design of the existing movable block 4, the damping pad 6 can be incorporated, after assembling, to an existing machine tool or parts mounting machine.

Furthermore, since the damping pad 6 is provided with a plurality of attenuation layers 9,—, heat generated on the table side is shut off from transferring to a motion guide device, thus achieving heat insulation effect.

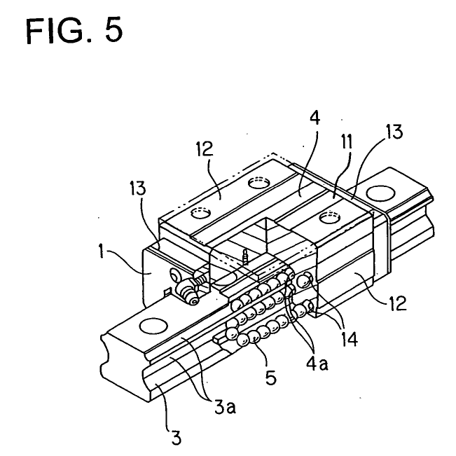

FIG. 5 shows the details of the motion guide device. This motion guide device includes a track rail 3 extending linearly as a track member and a movable block 4 mounted to the track rail 3 to be relatively slidable thereto. A number of balls 5,—as rolling members are disposed between the track rail 3 and the movable block 4.

The track rail 3 has lateral both side surfaces to which two rows of ball rolling grooves 3a, 3a are formed so as to extend in parallel with each other in the longitudinal direction of the track rail 3.

The movable block 4 includes a central flat portion 11 opposing to the upper surface of the track rail 3 and a side wall portions 12 extending downward at lateral both side end portions of the central portion 11 so as to oppose to the side surfaces of the track rail 3. The movable block 4 is also provided with a pair of end plates 13, 13 as side lids on both longitudinal end (moving direction end) of the movable block 4. The side wall portions 12 of the movable block 4 is formed with two rows of loaded ball rolling grooves 4a, 4a opposing to the ball rolling grooves 3a, 3a of the track rail 3, respectively. Two loaded ball rolling grooves 4a, 4a are formed vertically to each side wall portion 12 of the movable block 4, and thus, four loaded ball rolling grooves 4a, 4a are formed to both the side wall portions 12 to be parallel with each other.

The movable block 4 is further provided, on its side wall portions 12, with vertically two ball return passages 14, 14 disposed in parallel with each other at portions apart from the vertical two loaded ball rolling grooves 4a at a predetermined distance, and with U-shaped loaded ball rolling direction changing passage for circulating the balls 5,—by connecting the end portion of the loaded ball rolling groove 4a and the ball return passage 14. As mentioned above, a circuit-form ball circulation passage is constituted by the loaded ball rolling groove 4a, the paired direction changing passages and the ball return passage 14.

A number of balls 5,—are accommodated and arranged in the ball circulation passage. The balls 5,—may be coupled in series by means of a ball retainer or retainers.

The side lid (end plate) 13 has a sectional shape according with the movable block 4. Each of the side lids 13 is formed with an outer peripheral side of the direction changing passage. The side lid 13 is also formed with a lubricant supply passage for supplying a lubricant to the loaded ball rolling groove of the movable block body.

When the movable block 4 is moved with respect to the track rail 3, the balls 5,—roll and move, under the loaded state, between the ball rolling groove 3a of the track rail 3 and the ball rolling groove 4a of the movable block 4. The balls 5,—moved to one end of the loaded ball rolling groove 4a of the movable block 4 pass one direction changing passage on one side, the ball return passage 14 and the other one direction changing passage on the other side, in this order, and thereafter, roll again in the loaded ball rolling groove 4a. As mentioned above, at the time when the balls 5,—move from the non-loaded area to the loaded area, slight oscillation or vibration is caused. However, according to the damping pad 6 of the present embodiment, even such oscillation can be attenuated, thus being effective.

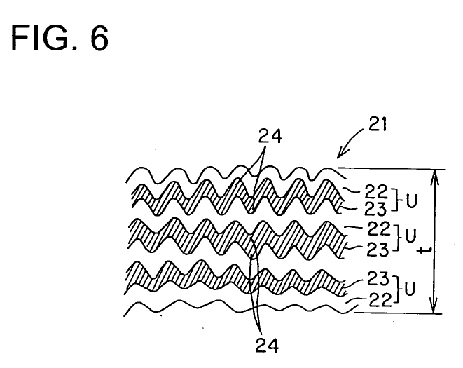

FIG. 6 shows the sectional view of another damping pad 21. This damping pad 21 is also composed of a lamination structure of a plurality of thin metal layers 22 and a plurality of attenuation layers 23 each having Young's modulus different from that of the metal layer 22, the metal layers 22 and the attenuation layers 23 being alternately laminated. The damping pad 21 of this embodiment is formed by pressing the metal layers 22 and the like so as to provide a corrugated (wave) shape. The attenuation layers 23, each formed of a rubber layer, are printed in form of corrugation on the corrugated metal layers 22, respectively. The damping pad 21 is formed by laminating a plurality of unit sheets U, each composed of the metal layer 22 on which the attenuation layer 23 is printed, and units U in which the attenuation layers 23 are printed are not laminated together. The metal layer is set so as to have a thickness of 20 to 40 μm, the attenuation layer is set so as to have a thickness of 5 to 10 μm, and the entire thickness of the damping pad is set to be less than 1.0 mm, and approximately, 0.5 mm in this embodiment.

The characteristic feature of this damping pad 21 resides in that the boundary face 24 between the metal layer 22 and attenuation layer 23 is formed so as to provide a corrugated shape which has crests and troughs, alternately. The corrugated shape of the boundary face 24 will increase an area of the boundary face 24 at a constant volume, which results in the increasing of an area for converting the oscillation energy to the heat energy, thus obtaining a further large attenuation force.

The damping structure of the present invention is not limited to the described embodiment and many changes and modifications may be made without departing the gist of the present invention. For example, the damping structure of the present invention may be arranged to various portions of machines required to attenuate oscillation or vibration without limiting to a position between the table and the motion guide device in a guide system as in the present invention. Furthermore, the damping structure of the present invention may be also incorporated in a motion guide device such as ball spline, ball screw or the like without being limited to a motion guide device such as linear motion guide.

Furthermore, it is to be noted that the various changes and modifications of the embodiments of the present invention mentioned above will be usable for embodying the invention. Thus, the patent claims of the present invention are ones for defining scopes of the invention, and structure and equivalent matters included in the claims should be embraced therein.

The entire disclosure of each of Japanese Patent Application Nos. 2003-155351 filed on May 30, 2003 and 2004-148908 filed on May 19, 2004 including the specification, claims, drawings and summary is incorporated herein by reference in its entirety.

1. A damping structure comprising a plurality of thin metal layers and a plurality of thin attenuation layers, each having a Young's modulus different from that of the metal layer, said metal layers and attenuation layers being laminated one by one alternately so as to provide an entire thickness of the damping structure to be not more than 1.0 mm.

2. The damping structure according to claim 1, wherein the damping structure has the entire thickness of not more than 0.5 mm.

3. The damping structure according to claim 1 or 2, wherein the metal layer has a thickness of 20 to 40 μm and the attenuation layer has a thickness of 5 to 10 μm.

4. The damping structure according to claim 1, wherein said attenuation layer is composed of a rubber or resin layer and is printed on the metal layer.

5. The damping structure according to claim 1, 2 or 4, wherein a boundary face exists between said metal layer and said attenuation layer so as to provide a corrugated shape having crests and troughs continuously alternately.

6. A motion guide device comprising a track rail and a movable block arranged to be slidable along the track rail, wherein a plurality of thin metal layers and a plurality of thin attenuation layers, each having a Young's modulus different from that of the metal layer, are laminated one by one alternately so as to provide an entire thickness of the damping structure to be not more than 1.0 mm.

7. A guide system comprising a base, a table and a motion guide device arranged between the base and the table so that the table is relatively movable with respect to the base, wherein said motion guide device includes a track rail mounted to the base and a movable block mounted to the table to be slidable along the track rail, in which a plurality of thin metal layers and a plurality of thin attenuation layers, each having a Young's modulus different from that of the metal layer, are laminated one by one alternately so as to provide an entire thickness of the damping structure to be not more than 1.0 mm.
